(19) United States
(12) Patent Application Publication
(10) Pub. No.: US 2012/0037438 A1
(43) Pub. Date: Feb. 16, 2012

(54) Hybrid Electric Vehicle Battery Protection System Through Capacitor Bank Energy Buffer

(76) Inventors: James Monroe Schultz, (US); Howard Dan Enslow, (US)

(21) Appl. No.: 12/856,966

(22) Filed: Aug. 16, 2010

(51) Int. Cl. B60K 6/28; B60K 6/42

(52) U.S. Cl. 180/65.22; 180/65.21; 903/903

(57) ABSTRACT

Delivery Truck/Bus Hybrid Vehicles, experiencing frequent starts, rapidly load their batteries with pulse surges during the first hundredths of a second of acceleration. Traditionally, battery life is maximized by minimizing initial discharge pulses and sustained discharge rates, with initial surges two to three times battery capacity (2C to 3C). Early Lead-acid or Lithium-ion batteries in hybrid buses with 3C discharges had their life expectancies reduced 50-75%. Recent “Lithium Ion/Nano Phosphate” batteries reportedly increase durability to 100C. If these 100C expectations are not met, battery life can be extended with a capacitor bank “floating in parallel” with the hybrid batteries. This helps dampen acceleration surges, as well as initial charging energy impulses, which extends battery life. Others have proposed parallel battery and capacitor banks but this patent uniquely focuses on matching capacitor energy, and thereby equipment, to the greatest surge demand, during the initial few hundredths of a second of acceleration.

### BACKGROUND OF THE INVENTION

1. Field of the Invention

This invention relates generally to a hybrid vehicle system that utilizes a combined battery and capacitor electrical energy storage system that reduces related wear and tear on the batteries when exposed to a start up energy surge that has the effect of “shock loading” the anode and cathode poles of the battery bank.

2. Discussion of the Related Art

Internal Combustion/Electric Hybrid vehicles are becoming more and more important as a means of maximizing fuel economy by fully utilizing and optimizing the energy systems of the vehicle, be it reducing the hydrocarbon fuel required for acceleration through supplemental battery stored energy, or capturing the braking energy through regenerative braking technologies.

Technologies have evolved so that an Internal Combustion Engine coupled to an electric motor/generator can work seamlessly with a battery bank to power the vehicle.

The battery bank is an array of lower voltage modules (possibly 6-12 Volts) connected in a series string to achieve the desired voltage, by example 230-400 volts, with the strings then connected in parallel to achieve the desired power requirements wherein current flows could be, for sake of this discussion, on the order of 6-10 Amp hours at the said voltage, more or less as per the designs of the manufacturer of the vehicle.

In hybrid truck and bus systems, typically the Internal Combustion Engine is sized significantly to match the power requirements of constant momentum, while the increased energy needs of acceleration, particularly as in moving forward from a dead stop, are provided by, or at least substantially assisted by, the battery bank.

At the instant that acceleration is initiated the battery bank experiences a dramatic outrush of energy as the electric motor windings offer no resistance to current flow till the magnetic flux fields are established in the motor. In these few hundredths of a second the electron outflow from the battery bank can be between 50-200% of normal steady state current flow. On a micro level within, by example a Lithium-Ion Battery, such a discharge surge causes Li⁺-ion particles to “explode” off of the Carbon Anode plates or film.

The introduction of a capacitor bank in parallel to the battery bank serves as an energy reservoir to cover the above instantaneous electrical surge, thereby reducing the demands on the battery system and thus extending the life of the batteries. Unlike a battery, rapid current flow off of and onto the metal plates of the capacitor does not impact the durability of the capacitor for upwards of a million cycles.

Once energy flows from the capacitor bank it will be replenished in the same manner as the battery bank when the hybrid system switches into recharging mode and current flows reverse.

If the customer so desires the capacitor bank could include electrical and/or electronic circuitry to activate indicator lights on the housing of the capacitor bank or enable the capacitor bank to be connected to the vehicles electronic and/or computer control systems.

As the customer desires the capacitor bank can be enclosed in a container, the sealing of which, the atmospheric conditioning of which and the electrical isolation of which, will be dictated by code requirements and customer necessities.

### SUMMARY OF THE INVENTION

In accordance with the teachings of the present invention, a hybrid vehicle system is disclosed that employs an ultra or super capacitor bank coupled in parallel with the battery bank of the hybrid system through a bus bar/line. In one embodiment the power and energy rating of the capacitor bank will be the same as the battery bank, and both are rated as capable of sustaining the same current flow. As the loading of the system changes the voltage swing of the bus bar/line, battery bank and capacitor bank will be the same owing to the parallel circuit configuration. The battery bank's energy demand in the first few hundredths of a second of acceleration is buffered by the capacitor bank, thus extending the life span of the batteries. During regular maintenance the capacitor bank and battery bank can be isolated from one another by means of a switch in series with the capacitor bank.

Additional advantages and features of the present invention will become apparent from the following description and appended claims, taken in conjunction with the accompanying drawings.

The remaining pages draw understandings from the above base patent and will be developed in conjunction with the discussion of the drawings.

### BRIEF DESCRIPTION OF THE DRAWING

FIG. 1 is a schematic block diagram of a hybrid vehicle, where the system includes a battery bank and a super capacitor bank connected in parallel wherein the energy demands placed on the battery bank are buffered by the capacitor bank, according to an embodiment of the present invention.

### DETAILED DESCRIPTION OF THE EMBODIMENTS

The following discussion of the embodiments of the invention directed to a hybrid vehicle system that employs a ultra/super capacitor and a battery is merely exemplary in nature, and is in no way intended to limit the invention or its applications or uses. For example, the battery bank and capacitor bank combination described herein has particular application for a hybrid vehicle. However, the battery bank and capacitor bank combination system may have other applications beyond vehicle applications.

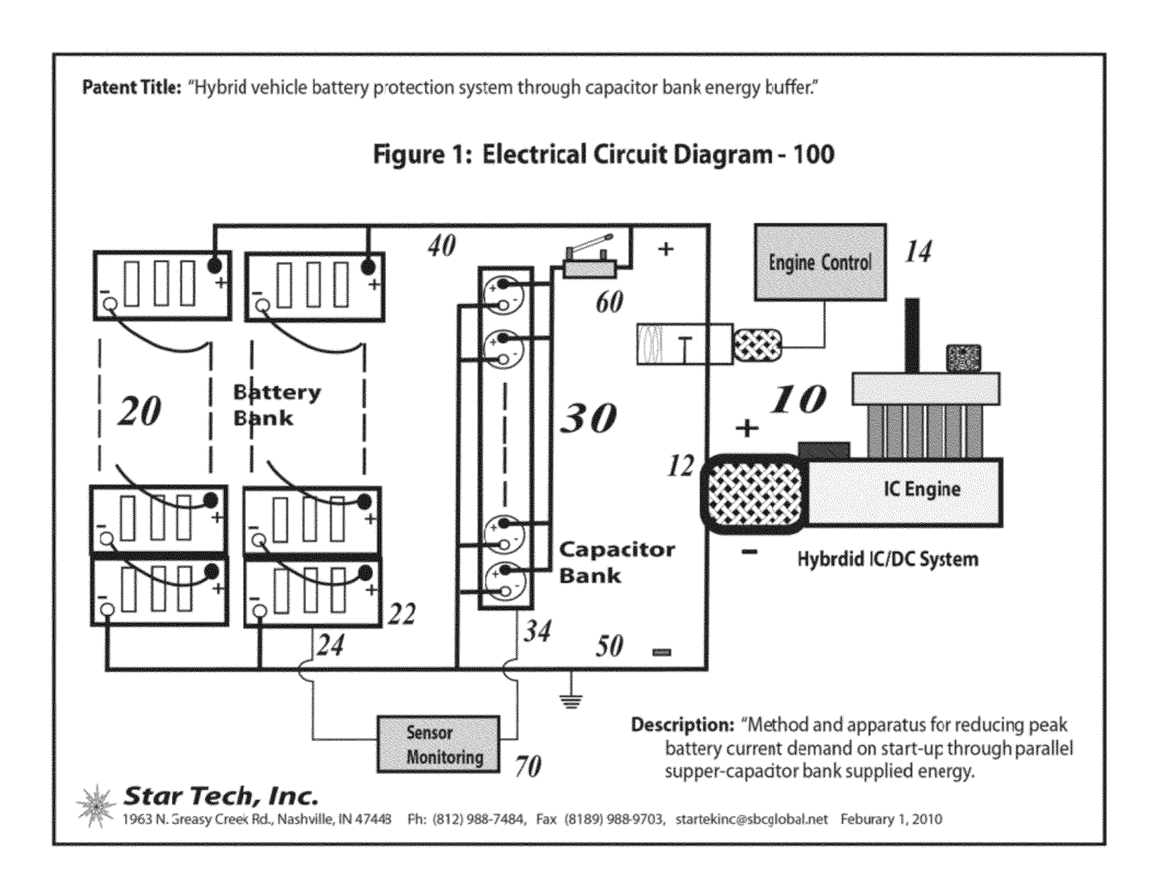

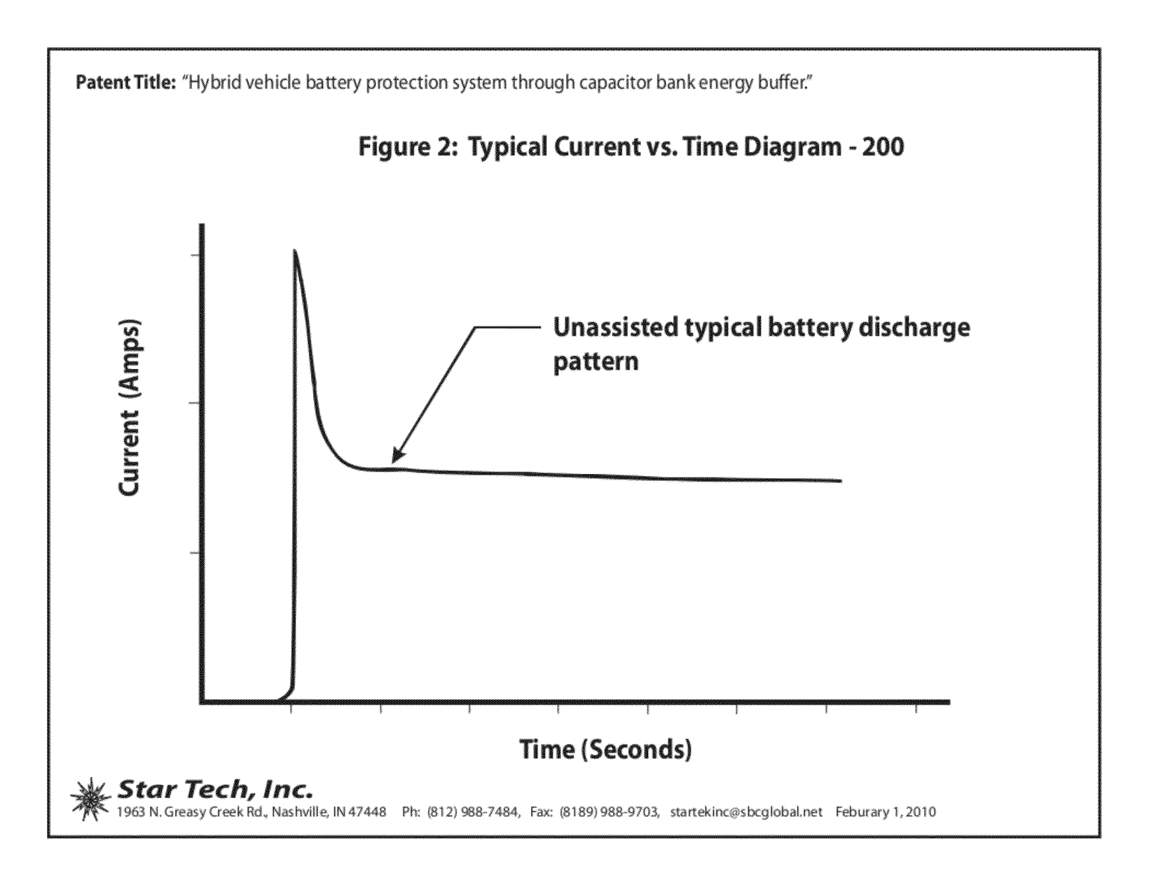

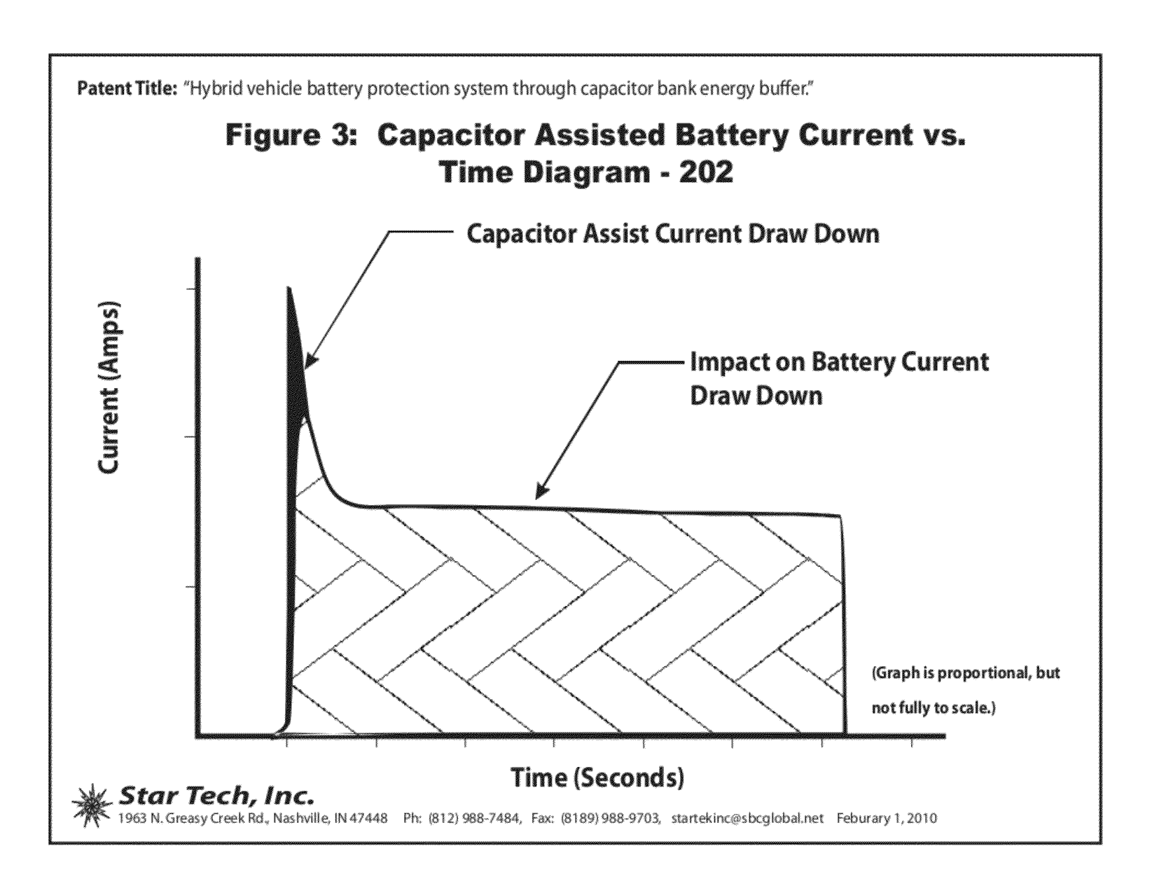

FIG. 1 is a schematic block diagram 100 of a hybrid vehicle internal combustion (IC) engine and electric system 10, complete with engine controls 14, provided by others, additionally including a battery bank 20 having an array of battery modules connected in series and parallel 22, also by others, electrically coupled in parallel with a capacitor bank 30. The battery bank and capacitor bank connected in parallel via a positive bus bar/line 40 and a negative bus bar/line 50 provides electrical power to the electric motor component 12 of the hybrid vehicle. On acceleration electrical energy will flow jointly from the battery bank 20 and capacitor bank 30 to the electric motor 12 with the initial first fractional amount of energy being provided by the capacitor bank 30 owing to the far lower amount of electrical resistance of the capacitor bank 30 compared to the battery bank 20. A switch 60, possibly manually operated, is connected in series between the positive bus bar/line 40 and the capacitor bank 30 that selectively disengages the capacitor bank 30 from the positive bus bar/line 40 for times of maintenance or if a safety shut down is required. As the battery bank 20 and the hybrid vehicle system are by others it would be their election to include a similar isolating switch for the battery bank 20.

According to the invention, the hybrid internal combustion/electric motor drive system 10 includes a battery bank 20 and a capacitor bank 30 electrically coupled in parallel to the positive bus bar/line 40 and the negative bus bar/line 50. As per detailed discussions below, the battery bank 20 and the capacitor bank 30 are discharged and charged simultaneously through the bus bar/lines during the operation of the system thereby reducing the initial shock to the battery bank 20 in first few hundredths of a second as most of the energy would flow from the capacitor bank 30 as previously stated. This difference in current flow is shown in the distinctions between FIG. 2 and FIG. 3. FIG. 2 shows the typical current outflow from the battery versus time, noting the dramatic discharge in the first fraction of a second. FIG. 3 highlights the effect of the capacitor bank ameliorating the impact of that initial current surge. In times of electrical recharging of the battery bank 20, such as in regenerative braking or idling, the capacitor bank would likewise be simultaneously be recharged.

The battery bank 20 is matched to the operating voltage of the hybrid vehicle system, by others, by means of a proper selection and connection of battery modules 22 in series to achieve the desired voltage and in parallel to achieve the desired Amp-hour rating. The battery bank 20 can be any rechargeable battery system, such as Lithium ion (Li-ion) batteries, a Nickel-metal-hydride (NiMH) batteries, Lead-acid batteries, or suitable others. The voltage specification of the Capacitor bank 30 is likewise matched to the operating voltage of the hybrid vehicle system, as per this invention, by selecting super capacitors which are either individually rated greater than the vehicles operating voltage or several capacitors in a series string, as in the battery example just noted, to achieve the desired voltage. Again, as in with the battery bank 20 above, individual or capacitor strings can be connected in parallel to enable the desired Amp-hour ratings so as to provide the desired amount of energy storage to sustain the system for the above specified fraction of a second.

A switch 60 selectively disengages capacitor bank 30 from the positive bus/bar line 40 to disconnect the capacitor bank 30 from the battery bank 20 when shut down/maintenance is required.

If others so elect, the battery bank 20 could include various sensors and the like for monitoring the temperature of the batteries 24, as well as their respective states of charge sensor monitoring system 70 that could be provided by others or the holder of the patent. Additionally, similar sensors could be attached to the capacitors 34 of the capacitor bank 30. A controller 14 exists within the hybrid motor, generator and battery system, as designed and provided by others, primarily to manage the state of charge of, and energy flow to, the battery bank 20. Given the fractional amount of energy in the capacitor bank 30 it can float in parallel with the battery bank 20 without needing additional controls. The said controller will also control other systems and switches consistent with the hybrid technologies discussed herein that are outside the prevue of this patent but are “well known in the trade”.

The hybrid internal combustion/electric motor drive system 10 includes a DC traction motor 12 as per the design and patents of others. The traction motor 12 provides the traction power to operate the vehicle, as is well understood in the art. The traction motor 12 can be any suitable motor for the purposes described herein. During regenerative braking when the traction motor 12 is operating as a generator, electrical DC power from the motor 12 is applied to the bus lines 40 and 50 to recharge the battery bank 10 and the capacitor bank 20.

Additionally, the battery bank 10 can be used for start-up and shutdown of the system 10, even when the capacitor bank 20 is empty.

The foregoing discussion describes and discloses and examples embodying the present configurations of the present invention. Those skilled in the art will readily recognize from such discussion and from the accompanying drawings and claims that various changes, modifications and variations can be made therein without departing from the spirit and scope of the invention as defined in the following claims.

1. A hybrid vehicle system comprising: an internal combustion engine {ICE} (either gas or diesel), an electrical generator/motor coupled to the ICE (both the engine and motor as per the design of others), a “battery bank” (an array of batteries in either/or parallel or series connection) of predefined voltage as per the design of the vehicle manufacturer, a capacitor bank (the primary object of this patent) of the same or greater predefined voltage as the battery bank and a means of electrically tying these together, commonly referred to as a “bus bar/line”.

2. The hybrid system according to claim 1 wherein the batteries of the battery hank are selected from the group consisting of a range of Lithium and Lithium-Ion batteries, Nickel-metal-hydride batteries, Nickel-Cadmium batteries, Lead-acid batteries or other appropriate batteries yet to be designed in the future as per the design of “others”, the vehicle manufacturer.

3. The hybrid system according to claim 1 wherein the capacitors are selected from the group consisting of super capacitors, double layer capacitors, ultra-capacitors and/or other similar construction as per the design of others and per the specifications of the vehicle manufacturer.

4. The hybrid system according to claim 1 wherein all of the capacitors in the capacitor bank are preferentially rated at, or above, the specified voltage of the Battery Bank. Alternatively, if the specified voltage is very high the above basic concept can also be achieved by connecting several capacitors in series to achieve the desired voltage, while a number of series strings would then be attached in parallel to affect the equivalent power capability. Whenever possible the design is much more robust if the capacitor's energy can be achieved by a parallel configuration as the failure of one capacitor in series eliminates the usefulness of the other capacitors in the string.

5. The hybrid system according to claim 1 where in the capacitors in the capacitor bank are connected via circuitry in parallel as much as possible within design and component capabilities.

6. The hybrid system according to claim 1 wherein the battery bank and the capacitor bank are connected in parallel via the bus bar/line.

7. The hybrid system according to claim 1 wherein the capacitors provide most of the power needed during the first few hundredths of a second of acceleration thus ameliorating the energy surge initially encountered by the battery bank which could be one, two or three times greater than normal operating currents and battery capacity (typically referred to as 1C, 2C or 3C rated current draw).

8. The hybrid system according to claim 1 wherein the energy capacity (technically, capacitance) of the capacitor bank, measured in kilo-Watt-Seconds, is sized to cover the first 0.05 to 0.10 of a second. Providing capacitance in this time frame covers the first surge energy spike which is the most damaging to a battery's life expectancy. Providing capacitance for more than a few hundredths of a second would increase cost, weight and size of the system beyond an optimum range without added benefit in terms of battery protection. This is because very quickly energy transfer to the battery pack would need to occur for the sustained 30 to 120+ seconds of typical acceleration. This is the unique feature of this patent, the sizing of a parallel capacitor bank to cover only the first few hundredths of a second of acceleration. Others have proposed batteries and capacitors working in parallel in hybrid vehicles but without the above optimizing specificity.

9. The hybrid system according to claim 1 wherein the capacitors and the batteries “float” at the same voltage, discharging and being charged at the same time as per a parallel circuit.

10. The hybrid system according to claim 1 further comprising a DC traction motor system electrically coupled to the power bus bar/line, said motor system providing a voltage on the power bus bar/line during regenerative braking for recharging the battery and the capacitors as per the design of others.

11. The hybrid system according to claim 1 further comprising a switch in series with the capacitor bank so, the capacitors and the battery system can be isolated from each other for repairs or service.

12. The hybrid system according to claim 1 in which, at the customer's request, electrical circuitry is included to enable indicator lights to identify the state of charge or functionality of the individual capacitors.

13. The hybrid system according to the claim 1 in which, at the customer's request, electrical circuitry and/or electronic circuitry is included to enable the capacitor bank to be connected to a vehicle's electronic or computer monitoring system to identify the state of charge or functionality of the individual capacitors.

14. The hybrid system according to claim 1 in which the capacitor bank is enclosed in an electrically isolated container as per appropriate governmental, professional and safety code requirements, and customer specifications that may vary from customer to customer. At the customer's request, these containers may be hermetically sealed.

15. The hybrid system according to claim 1 in which the capacitor bank enclosure is also isolated from vibrations in a manner to be agreed upon by the customers.

16. A hybrid vehicle system comprising: an electrical power bus bar/line; an internal combustion engine driving an electric motor/generator coupled to the bus bar/line; a battery bank electrically coupled to the power bus bar/line; and a super capacitor bank electrically coupled to the power bus bar/line sized and optimized to handle the energy requirements of the first few hundredths of a second of operation, all being in parallel and common voltage so that together they provide energy matching the initial surge requirements of the motor/generator during start up acceleration.
